(19) United States
(12) Patent Application Publication
(10) Pub. No.: US 2013/0342316 A1
(43) Pub. Date: Dec. 26, 2013

(54) Sensor-Enabled RFID System to Gauge Movement of an Object in Relation to a Subject

(71) Applicants: Touraj Ghaffari, Boca Raton, FL (US); Gitendra Uswatte, Birmingham, AL (US); Joydip Barman, Pelham, AL (US); Nilanjan Sarkar, Brentwood, TN (US)

(72) Inventors: Touraj Ghaffari, Boca Raton, FL (US); Gitendra Uswatte, Birmingham, AL (US); Joydip Barman, Pelham, AL (US); Nilanjan Sarkar, Brentwood, TN (US)

(21) Appl. No.: 13/532,765

(22) Filed: Jun. 25, 2012

(51) Int. Cl. G08C 17/02

(52) U.S. Cl. 340/10.1

(57) ABSTRACT

The present disclosure describes a system of radio frequency identification (RFID) tags paired with RF proximity sensors and movement sensors for measuring the movement and use of objects in an environment. The movement gives an indication of the user's ability to use his or her motor skills in a medical or recovery setting, or any other setting using a variety of objects. Data may be read, stored and processed to represent position, speed and movement of the objects by a critical body part, such as a limb, analyzed and plotted, to gauge a patient's improvement.

### FIELD OF THE DISCLOSURE

The present disclosure relates generally to the tracking of objects in an environment using sensor-enabled technology. The present disclosure relates more specifically to the tracking of objects in an environment using sensor-enabled radio frequency identification technology.

### BACKGROUND OF THE DISCLOSURE

The use of sensor enabled technology to monitor and record the movement of objects in an environment is a growing area of art. In particular, the use of sensor-enabled radio frequency identification (RFID) is of particular interest. RFID is a technology that uses communication through the use of radio waves to transfer data between a reader and an electronic tag attached to an object for the purpose of identification and tracking. RFID technology makes it possible to give each item in an environment its own unique identifier and to record the interaction of the item with its environment. For example, it is possible to determine the location of the item, the movement or use of the item over time and/or space and to record the interaction of the item with the environment. RFID technology has a number of applications including, but not limited to, the consumer product field, manufacturing field and healthcare/rehabilitation field. The use of RFID technology allows such process to occur in real-time and with a number of objects in an environment.

For example, the use of RFID technology has a number of applications in the medical/rehabilitation field. As one example, RFID technology may be used to monitor the use of objects in an environment by a patient undergoing rehabilitation from a disease or injury that impairs motor function. Stroke survivors represent one category of such patients. More than 650,000 patients survive strokes annually in the United States [1]. Persistent impairment of the arm on the more-affected side of the body afflicts between 55% and 75% of survivors [2] and is associated with diminished health-related quality of life [3]. Advances in methods to assess and treat more-affected arm impairment after stroke, therefore, have the potential to improve the lives of many.

Well-known models of disability and data indicate that laboratory measures of function poorly index how stroke survivors actually use their more-affected arm in daily life [4]. Therefore, substantial effort has been spent on developing real-world measures of arm function. Most of these tests, however, rely on self-report [4]. Researchers have objectively measured amount of arm activity in the community by placing accelerometers on stroke survivors [5]. These techniques, however, cannot discriminate whether a given arm movement is functional or non-functional and cannot identify what tasks were performed. In addition it is not possible to track which objects are being used by the patient and for how long.

It would be desirable to have a system that could accurately track the use of objects in an environment by such a patient that would allow a caregiver to identify the objects being used, the extent of use of such objects, the tasks that were being performed by the patient and whether such tasks were being performed in a desired manner. In addition, it is desirable that such a system be transparent in operation to the patient.

The present disclosure describes a system of radio frequency identification (RFID) tags paired with RF proximity sensors and movement sensors for measuring the movement and use of objects in an environment. In this approach, movement sensors (for example, accelerometers) are placed on objects, along with one component of a RF proximity sensor. The other component of the proximity sensor is connected to an active RFID tag and placed on a subject or second object of interest. Manipulation of instrumented objects in the environment produces synchronous signals from the movement and proximity sensors, permitting tracking of which objects are manipulated, when manipulation takes place, and whether such manipulation is by the subject or object of interest.

In one particular application, the system is used to monitor the activity of a limb, such as but not limited to, an arm or leg, in a subject undergoing rehabilitation from an injury or disease that impairs the use of the limb. In one application, the limb is an arm. In this system, radio frequency identification (RFID) tags are paired with proximity and movement sensors for measuring arm activity. In this approach, movement sensors (i.e., accelerometers) are placed on objects in the environment of the patient, along with one component of a RF proximity sensor. The other component of the proximity sensor is connected to an active RFID tag and placed on the arm of interest. Manipulation of instrumented objects in the environment with the arm of interest produces synchronous signals from the movement and proximity sensors, permitting, tracking of which objects are handled, when handling takes place, and whether handling is by the person and arm of interest. The proposed approach, thus, can collect much richer objective data than possible now.

As a result, the system of the present disclosure allows the collection of a much richer objective data set than possible using the methods and devices of the art.

### BRIEF DESCRIPTION OF THE DRAWINGS

FIG. 1 shows one embodiment or the system of the sensor-enabled RFID system for monitoring arm activity (SERSMAA) system of the present disclosure.

FIG. 2 shows an alternate and parallel embodiment of the sensor-enabled RFID system for monitoring arm activity (SERSMAA) system of the present disclosure wherein a tilt sensor is used as a movement sensor in place of an accelerometer on the objects.

FIG. 3 shows yet another embodiment of the sensor-enabled RFID system for monitoring arm activity (SERSMAA) system of the present disclosure implemented as a passive tag system.

FIG. 4 shows one embodiment of a low-frequency radio transmitter circuit block diagram.

FIG. 5 shows one embodiment of a low-frequency radio transmitter circuit block diagram.

FIG. 6 shows graphs performance of the sensor-enabled RFID system for monitoring arm activity (SERSMAA) system illustrating joint operation of the proximity and movement sensors when the object to be moved and arm of interest were randomly selected. Manipulation of the object of interest with the arm of interest was detected with 100% sensitivity and specificity both when the objects were 43 and 5 cm apart.

### SUMMARY OF THE DISCLOSURE

In a first aspect, the present disclosure provide a system for detecting movement of an object in an environment, the system comprising a movement sensor, a RF proximity sensor transmitter and a RF proximity sensor receiver. In one embodiment of the first aspect, the movement sensor and the RF proximity sensor transmitter are attached to the object of interest and the RF proximity sensor receiver is used in conjunction with the subject or a second object of interest.

In a second aspect, the present disclosure provide a system for detecting movement of an object in an environment, the system comprising a movement sensor, a RF proximity sensor transmitter, a RF proximity sensor receiver and at least one of the following: an RFID reader, a processing device and a network for allowing communication between the RFID reader and the processing device. The system may further comprise a movement sensor transmitter. In one embodiment of the second aspect, the movement sensor and the RF proximity sensor transmitter are attached to the object of interest and the RF proximity sensor receiver is used in conjunction with the subject or a second object of interest.

In a third aspect, the present disclosure provide a system for detecting movement of an object in an environment; the system comprising a movement sensor, a RF proximity sensor transmitter, a RF proximity sensor receiver and at least one of the following: an RFID reader, a movement sensor transmitter, a movement sensor reader, a processing device and a network for allowing communication between the RFID reader, movement sensor reader and the processing device. In one embodiment of the third aspect, the movement sensor, movement sensor transmitter and the RF proximity sensor transmitter are attached to the object of interest and the RF proximity sensor receiver is used in conjunction with the subject or a second object of interest.

In a fourth aspect, the present disclosure provides a system for detecting movement of an object in an environment, the system comprising a movement sensor, a RFID reader with short read range, a passive RFID tag, and at least one of the following: a movement sensor transmitter, a movement sensor reader, a processing device and a network for allowing communication between the RFID reader, movement sensor reader, and the processing device. In one embodiment of the fourth aspect, the passive RFID tag is attached to the object of interest and the RFID reader, movement sensor, movement sensor transmitter are used in conjunction with the subject or a second object of interest. In another embodiment of the fourth aspect, both a movement sensor and a movement sensor transmitter are attached to the object of interest in addition to the passive RFID tag.

In a fifth aspect, the systems of the first through fourth aspects are used in a system for remotely monitoring the relationship between a first object and a second object over short distances. In one embodiment, a short distance is defined as a distance from 1-40 cm. In one embodiment, the first object is a household item, a consumer product, a tool, or an item used in a manufacturing process and the second object is a limb of a subject, such as an arm or a leg.

In a sixth aspect, the systems of the first through fourth aspects are used in a system for remotely monitoring the use or handling of a first object by a second object over short distances. In one embodiment, a short distance is defined as a distance from 1-40 cm. In one embodiment, the first object is a household item, a consumer product, a tool, or an item used in a manufacturing process and the second object is a limb of a subject, such as an arm or a leg.

In a seventh aspect, the systems of the first through fourth aspects are used in a system for remotely monitoring everyday arm activity in a subject. In one embodiment, the arm of the subject has impaired function.

In an eighth aspect, the systems of the first through fourth aspects are used in a system for remotely monitoring compliance with home exercise programs.

In a ninth aspect, the systems of the first through fourth aspects are used in a system for therapeutic use of activity monitoring records.

In a tenth aspect, the systems of the first through fourth aspects are used in a system for remotely tracking how often a consumer handles a particular product in a commercial setting or in a home setting.

In an eleventh aspect, the systems of the first through fourth aspects are used in a system for remotely monitoring what an employee handles on a production or manufacturing line.

In a twelfth aspect, the systems of the first through fourth aspects are used in a system for monitoring control of the ball by a player or players in a sport.

### DETAILED DESCRIPTION

The present disclosure describes a system of radio frequency identification (RFID) tags paired with RF proximity sensor transmitters, RF proximity sensor receivers and movement sensors for measuring the relationship, movement and/or use of objects in an environment. Movement sensors are placed on objects, along with one component of a RF proximity sensor. the RF proximity sensor transmitter. The other component of the proximity sensor, the RF proximity sensor receiver, is in communication with an active RFID tag and placed on a subject or second object of interest (for example, the affected arm of a patient or a tool used in a manufacturing process). Manipulation of instrumented objects in the environment produces synchronous signals from the movement and proximity sensor, permitting tracking of which objects are manipulated, when manipulation takes place, and whether such manipulation is by the subject or object of interest. In one embodiment, the components of the system are constructed so that such measuring occurs over a short distance. In one embodiment, a short distance is defined as a distance from 1-40 cm, from 1-35 cm, from 1-25 cm or from 1-21 cm.

To overcome the limitations of sell-reporting, the art has employed the use of accelerometers to objectively measure the amount of arm activity in stroke survivors [5]. For example, Uswatte et al. [6] asked stroke survivors with mild-to-moderate impairment of their more-affected arm to wear an accelerometer above each wrist during all waking hours for 2 days before and after upper-extremity physical rehabilitation or a corresponding no-treatment period. They found that the ratio of more-affected to less-affected arm accelerometer recordings was strongly correlated with amount of more-affected arm use in daily life (r=0.74. p<0.001). However, since any arm movement produces an acceleration reading, such approaches cannot discriminate whether a given movement is functional or non-functional nor identify what tasks are performed.

RFID systems consist of small tags that transmit a unique ID using a RF and a RF reader that monitors the status of these tags [7]. Software on a PC connected to the reader processes the RFID signals. “Passive” RFID tags transmit their ID when they encounter the reader's radio waves, whereas “active” RFID tags, which are battery powered, transmit their ID independently to a reader from as far as 85 m [8]. Typical applications involve tracking whether tagged objects are within the range of the reader or not. Examples are monitoring when hospital equipment or a patient leaves a room and monitoring how much merchandise remains in a warehouse [9]. RFID systems have not been used to remotely monitor activity in a patient rehabilitation setting, such as monitoring the use of limbs or upper-extremity activity.

The system of the present disclosure will be exemplified using an example adapted for use in the patient rehabilitation setting. However, it is to be understood that the system of the present disclosure may be utilized in non-rehabilitation and non-healthcare setting and that the components of the system would operate in the same manner as described herein in such other settings. Examples of the other settings include product manufacturing, use and in sports.

In one embodiment, the system of the present disclosure comprises a movement sensor, a RF proximity sensor transmitter and a RF proximity sensor receiver; the RF proximity sensor transmitter and the RF proximity sensor receiver comprise an RF proximity sensor. The system may further comprise an RFID reader, a processing device, such as, but not limited to a computer, and a network for allowing communication between the RFID reader and the processing device. The operation of the various components is described in more detail below. The system may further comprise a movement sensor transmitter and a movement sensor receiver. Such components may operate as described below for the RF reader or as known in the art. In one embodiment, the movement sensor and the RF proximity sensor transmitter are attached to the object of interest and the RF proximity sensor receiver is used in conjunction with the subject. In one embodiment for use in rehabilitation setting the system may be referred to as a sensor-enabled RFID system for monitoring arm activity (hereinafter, SERSMAA).

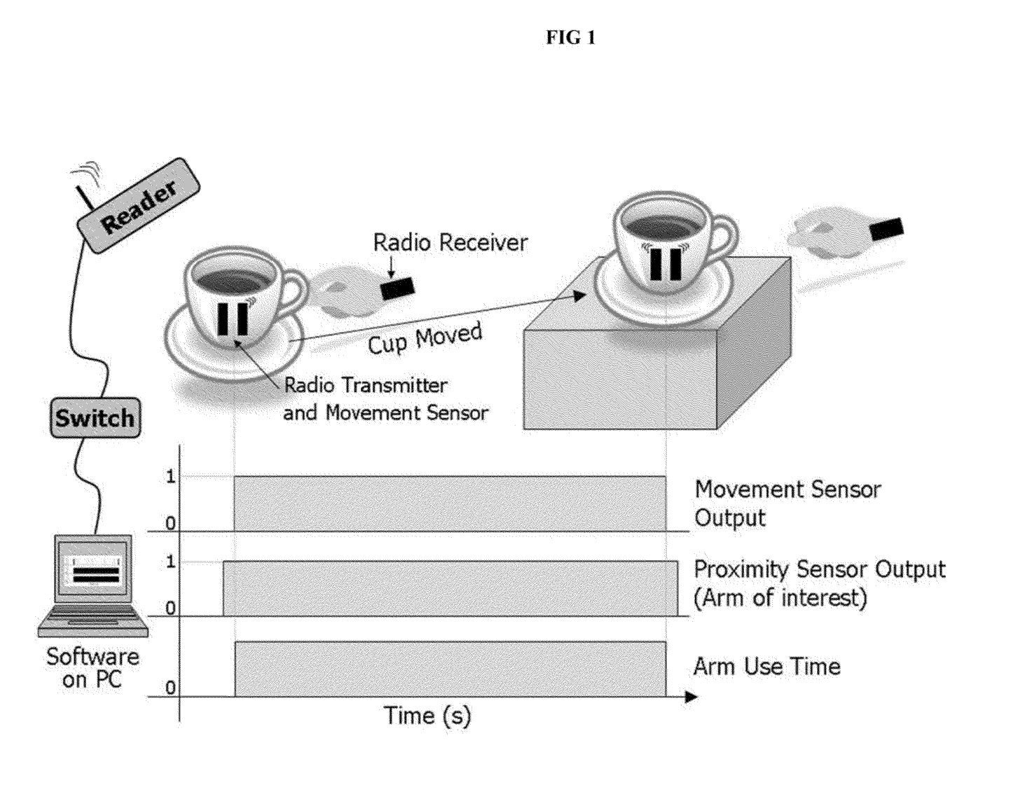

FIG. 1 shows one embodiment of an exemplary hardware setup for the SERSMAA system and illustrates how the various components of the SERSMAA system operate together when an object is manipulated with the arm of interest. In this example, the movement sensor and the RF proximity sensor transmitter are used in conjunction with an object of interest and the RF proximity sensor receiver is used in conjunction with an arm of interest on the subject. The arm of interest may be the arm that is subject to impairment. In addition, more than one RF proximity sensor receiver may be used; for example, the subject could have a RF proximity sensor receiver on each arm. As discussed below, the signals generated from each RF proximity sensor receiver can be discerned from one another based on the unique identifier tags used.

When the arm of interest (an arm on which a RF proximity sensor receiver is placed) approaches an instrumented object, the RF proximity sensor receiver detects the RF proximity sensor transmitter's signals. On detection of the RF proximity sensor transmitter's signals, the RF proximity sensor receiver triggers the RFID tag to broadcast an “ON” signal, along with its unique ID. When the arm of interest withdraws, the RF proximity sensor receiver no longer detects the RF proximity sensor transmitter's signals. On cessation of detection of the RF proximity sensor transmitter's signals, the, the RF proximity sensor receiver triggers the RFID tag to broadcast an “OFF” signal along with its unique ID. Time stamps may also be transmitted by the RFID with the on and off signals along with the unique ID; in an alternate embodiment. the time signals may be added by the RF reader or the processing device. The RFID signals are read by RF reader and the RF reader relays the proximity status signals to the processing device for storage and/or processing of the signals. The processing device processes the received signals and stores the output in an appropriate format and data file. In one embodiment, the format is a text file. The processing device may comprise which custom software to aid in the foregoing processing and storage steps.

If the object of interest is manipulated, the movement sensor records the changes in its acceleration. The data generated by the movement sensor on each object of interest also includes a unique ID to allow identification of the object of interest. The movement sensor may store these values in on-board memory for offline downloading to the processing device. Alternately, the movement sensor may be connected to a transmitter, which may be a RFID tag, that communicates the movement sensor recordings ultimately to the processing device. The movement sensor data may be processed and stored into an appropriate format and date file, such as a text file. The processing device processes the data files from the proximity and movement sensor files; in one embodiment, such processing is done offline. In another embodiment. processing of the movement sensor recordings, in conjunction with the proximity sensor recordings, is done in real time. Synchronous “positive” values from the proximity and movement sensors indicate that an instrumented object is being moved by an arm of interest. Moreover, analysis of the proximity status and acceleration values, along with their ID and time stamps, permits tabulation of which objects are moved, when they are moved. for how long, and by which arm.

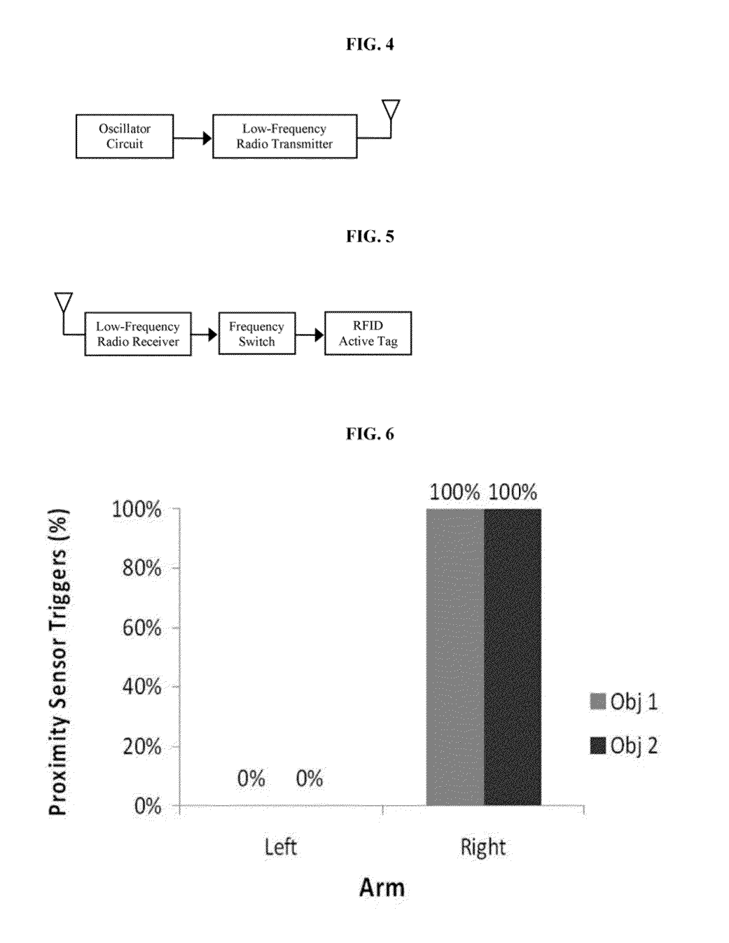

FIGS. 4 and 5 shows exemplary block diagrams of one embodiment of the RF proximity sensor transmitter and RF proximity sensor receiver components, respectively, of the RF proximity sensor. As noted, RF proximity sensor transmitters are attached to objects, while the RF proximity sensor receiver is attached to an arm of interest. In operation, the RF proximity sensor transmitter sends a trigger signal to the RF proximity sensor receiver at a fixed low frequency. In one embodiment, the trigger signal is a 30 Hz oscillator signal transmitted at a fixed low frequency of ˜10.7 KHz. A low-frequency is desirable for sensing proximity of the RF proximity sensor receiver and RF proximity sensor transmitter over distances useful for detecting when an arm of interest is close to an instrumented object (i.e., an object of interest). In one embodiment, this distance is from about of 1 to 23 cm. Furthermore, the trigger signal may be set to minimize interference from commonly encountered electronic devices present in the environment. The RF proximity sensor receiver is tuned to the same frequency as the RF proximity sensor transmitter. It should be noted that other trigger signals may be used as appropriate to increase the distance of detection between the RF proximity sensor transmitter and the RF proximity sensor receiver. In one embodiment, the trigger signal is a signal that will allow detection over a distance of 15 to 38 cm.

The RF proximity sensor receiver triggers the RFID tag to emit a radio signal. In one embodiment, the RF proximity sensor receiver output connects to a frequency switch circuit that turns ON when it reads the trigger signal and turns OFF in the absence of the trigger signal. When the frequency switch circuit is ON, a signal the RFID tag sends a signal which is detected by the RF reader indicating a change in sensor status as discussed above. The activation of the RFID tag can be direct or indirect. In the embodiment described in the present disclosure, the activation of the RFID tag is indirect due to the configuration of the RFID tag used (ActiveWave RFID tag). In this particular RFID tag, the frequency switch output cannot be readily connected to the RFID tag [8]. To allow for communication between the RF proximity sensor receiver and the RFID tag, the frequency switch output connects to an electromagnet, which produces a magnetic field when the frequency switch toggles ON. This magnetic field, in turn, activates an ActiveWave magnetic sensor active RFID tag, which sends a signal to the RF reader indicating a change in sensor status. In an alternate embodiment, the frequency switch output fires the RFID tag directly when the frequency switch toggles ON. A conventional power source is used to power both components. In one embodiment, the power source for both components is 3 V coin cell batteries. Any RFID tag known in the art may be used in conjunction with the system described herein.

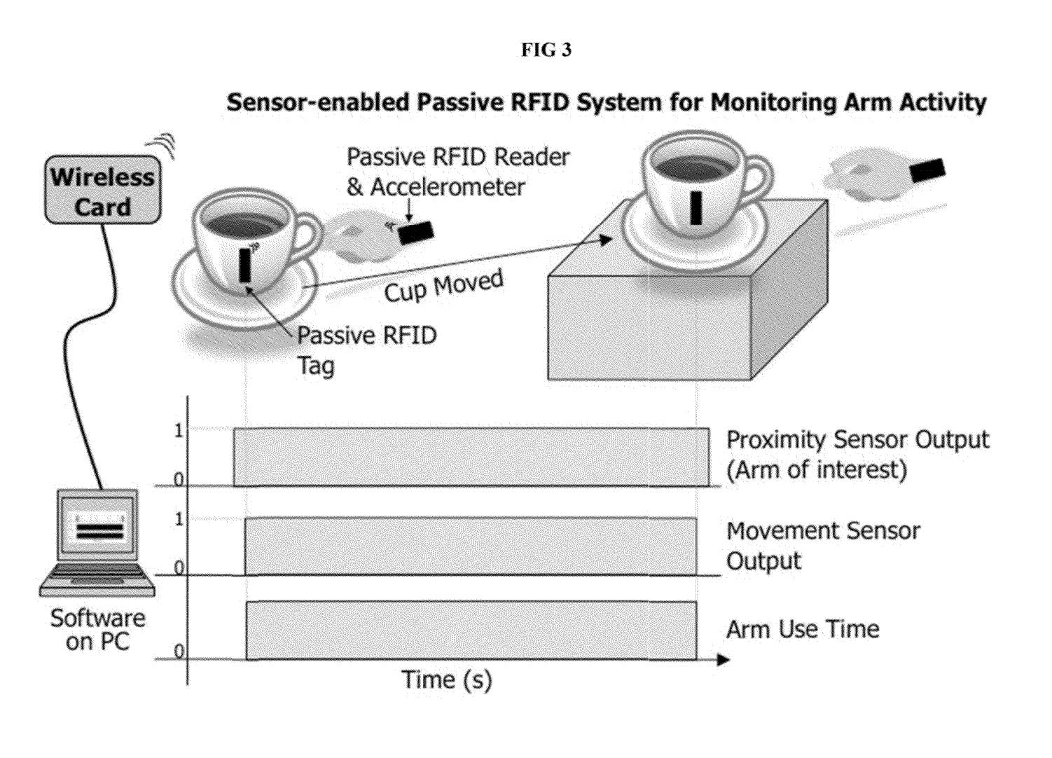

The RFID tag may be an active RFID tag or a passive RFID tag. If a passive RFID tag is used, the RF reader may be positioned on the arm of the user to interrogate and receive signals from passive RFID tags attached to objects of interest. Furthermore, an accelerometer (as described herein) may be placed on the arm of the user as well. FIG. 3 illustrates the use of a passive RFID tag as opposed to an active one in an alternate embodiment to the one illustrated in FIG. 1. Note that both the RFID reader on the arm and the transmitter on the object are energized by the power of the proximate wireless card, which should be at a suitable distance so as to energize both components.

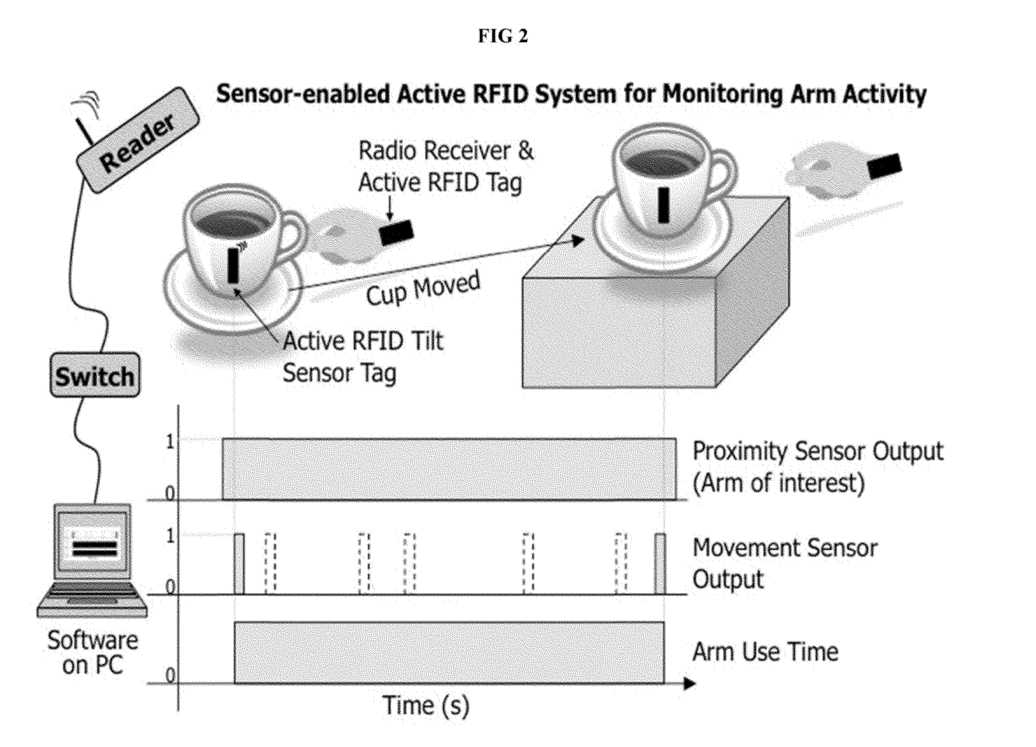

The movement sensors may be any movement sensor known in the art. In one embodiment, the movement sensor is a biaxial movement sensor. In one embodiment, the movement sensors are ActiGraph GTIM Activity Monitors. The movement sensor may incorporate an accelerometer in two or three axis (a biaxial or triaxial accelerator); in one embodiment, a biaxial accelerometer is used. Likewise, a tilt sensor or gyroscopic sensor can be used as shown in the example in FIG. 2. The GTIM units employ a biaxial accelerometer. which detects 1 g acceleration with a sensitivity of ±10%. Acceleration is sampled at 60 Hz in each axis. These samples are integrated separately for each axis over a user-specified epoch, such as for example 1 s, and are stored in 1 Mb flash memory [10]. To remove non-functional movement (e.g., simply brushing the arm or interest against an object), integral values≦1 are set to 0; other values are set to 1 [11]. To generate a single ON/OFF movement signal, the movement status in each epoch is set to OFF only if the threshold-transformed integral values tor both axes are 0. Otherwise, movement status is set to ON. Biaxial accelerometers are adequate for monitoring arm activity because manipulation of objects invariably results in movement components in all 3 axes [12].

A communication network is established between the processing device and RF reader. In one embodiment, the communication network is a local area network (LAN); in a particular embodiment, the LAN utilizes an Ethernet 10/100 Mbps switch. The switch enables the RF reader and processing device to communicate reliably over the LAN. In a particular embodiment, the processing device is a computer.

### Testing, Procedure

Benchmark testing was performed under highly controlled conditions in the laboratory to determine whether the sensitivity and specificity of the SERSMAA system was adequate (i.e. ≧98% sensitivity and >99%, specificity).

### RF Proximity Sensor Testing

To evaluate the RF proximity sensor, a number of test (referred to below as Test 1a-1f) were conducted. In these tests, the proximity sensor transmitter was attached to the side of a coffee mug using Velcro. The RF proximity sensor receiver was attached with an elastic hand to the right forearm of the experimenter just above the wrist. The mug was placed on a target at the center of several circles of varying radii drawn on a table. Two hundred trials of each test were conducted, except for Test 1a, which had 100. The start and end of trials were marked with beeps emitted by custom software on a personal computer.

To determine the range of proximity detection, the experimenter moved his hand along the table top in 1 cm increments every 5 s starting from a target 24 cm away from the mug and ending 20 cm away. Movement was parallel to the y axis of the mug. Proximity sensor status was recorded at each 1 cm increment. This test is referred to as Test 1a.

To evaluate how sensitivity varies with angle of approach, the experimenter placed his hand on a target>23 cm from the mug. The experimenter then grasped the mug handle with his right hand, released it, and returned his hand to the target. This movement was conducted parallel to the x, y, and z axes of the ma in separate sets of trials. This test is referred to as Test 1b.

To evaluate how sensitivity varies with interval between releasing and grasping an object. the y-axis text was repeated with inter-trial intervals of 1, 3, 5, and 7 s. This test is referred to as Test 1c.

To determine how sensitivity varies with type of household object and hand size, the y-axis test was repeated with a telephone, book, hair brush, and television remote and with experimenters with hand sizes ranging from 18.5 to 21.5 cm (tip of middle flinger to styloid process of radius). This test is referred to as Test 1d.

To evaluate specificity, the proximity sensor receiver was set>23 cm away from any transmitters for 24 hours. This test is referred to as Test 1e.

To test robustness to interference from other electronic devices that emit RF waves, the y-axis test was repeated at varying distances from a loud speaker and television set. This test is referred to as Test 1f.

### Movement Sensor Testing

To evaluate the movement sensor, a number of test (referred to below as Test 2a-2d) were conducted. In these tests, the movement sensor was attached to the side of a coffee mug using Velcro.

To test how sensitivity varies with distance an object is moved; the experimenter moved the mug from one target to another on the table surface parallel to the x axis of the mug. Two hundred trials each were conducted with the targets 2, 4, 6, 8, 12 and 16 cm apart. The interval between trials was 3 s. This test is referred to as Test 2a.

To test how sensitivity varies with direction of movement, the 12 cm test above was repeated with movements parallel to the y and z axes of the mug. This test is referred to as Test 2b.

To test how sensitivity varies with interval between movements, the 12 cm test for movement parallel to the mug's x axis was repeated with a 2 s inter-trial interval. This test is referred to as Test 2c.

To evaluate specificity, a movement sensor was turned on and left in one spot for 24 hours. This test is referred to as Test 2d.

### Testing of the System

To test the sensitivity and specificity of the entire system, RF proximity sensor transmitters and movement sensors were attached to two mugs (Mug 1 and 2) resting 43 cm apart. The RF proximity sensor receiver was put on the experimenter's right arm. The experimenter placed his right and left hands on separate targets each>23 cm from both mugs. When instructed, the experimenter grasped either Mug 1 or 2, moved it to a target 12 cm away with either his right or left hand, and returned the hand employed to its starting position. Two hundred trials were conducted, with 5 s between trials. This procedure was repeated with objects set 5 cm apart. The choice of which object to grasp and which arm to employ was determined by a random process on each trial.

### Data Processing and Analysis

The RF proximity sensor and movement sensor data were stored as text files in this example. A VB.NET software algorithm was developed to process the files offline. The algorithm combined the two files by using the time and ID stamps in these files as keys. Summary variables were then calculated for each test: number of times the experimenter's right arm approached each object (i.e., proximity status transitions from ON to OFF); number of times each object was moved (i.e., movement status transitions from ON to OFF); number of times each object was manipulated by the experimenter's right arm (synchronous transitions from ON to OFF status for the proximity and movement sensors). Changes in sensor status were deemed synchronous if the transitions in status from each sensor type were within 2 s of each other. Other summary variables that can be derived are how long each Object is moved and manipulated. In addition, total time the arm of interest is used to manipulate objects can be derived by summing across objects.

### Results

The RF proximity sensor receiver on the experimenter's right arm detected proximity of an instrumented mug in 100% of trials when the mug was <21 cm away. When the mug was 22 cm and 23 cm away, sensitivity fell to 95% and 90%, respectively. When the mug was >23 cm away, i.e., outside of the intended range, the RF proximity sensor receiver, appropriately, did not change status. Sensitivity did not vary substantially with angle of approach. Out of 200 approach. grasp, release, and withdraw trials, proximity was detected 202, 198, and 204 times, respectively, for angles parallel to the x, y, and z axes of the mug. Proximity detection did not vary substantially with interval between trials (1 s=194, 3 s=202, 5 s=198); type of object grasped (mug=198, telephone=203; book=198; hair brush=194, remote control=196): or experimenter hand size (18.5 cm=198, 19.6 cm=202, 21.5 cm=204). Specificity was supported; no proximity detection signals were recorded when the proximity sensor receiver and transmitter were kept ≧23 cm apart for 24 hours. In addition, proximity was detected during only 0.4% of inter-trial intervals during the above tests. Operation of a television set and loud speaker interfered with proximity detection; when the RF proximity sensor receiver and RF proximity sensor transmitter were within 20 cm of each other but ≦20 cm from one of these electronic devices the RF proximity sensor receiver failed to detect proximity.

When the experimenter moved an instrumented mug 6 cm or more, the movement sensor detected ≧99% of the movements. For 4 cm movements, detection was 90%. For 2 cm movements, detection was only 57%. Sensitivity did not vary substantially with direction of movement. For 12 cm movements parallel to the x, y, and z axes of the mug, detection was 99%, 99%, and 98%, respectively. Detection was poor when the interval between movements was ≦2 s. For a 12 cm movement parallel to the x axis of the mug, detection was 99% when the inter-trial interval was 3 s but was only 48% when the inter-trial interval was 2 s. Specificity was supported; no movement was recorded when a movement sensor was turned on but kept in one spot for 24 hours. In addition, for tests where the inter-trial interval was ≧3 s and movement was ≧4 cm, no movement was detected during the inter-trial intervals.

FIG. 6 graphs performance of the SERSMAA system (the joint operation of the RF proximity sensor transmitter and receiver and the movement sensors) when the object to be moved and arm to be employed was randomly selected. Manipulation of the object of interest with the right arm was detected with 100% sensitivity and specificity both when the objects were 43 and 5 cm apart.

The sensitivity and specificity of the SERSMAA system under controlled conditions in the laboratory was shown to be sufficient for remotely monitoring everyday arm activity after stroke. When the proximity sensor receiver on the experimenter's right arm drew close (≦21 cm) to an instrumented object, proximity was detected on ≧97% of trials, regardless of angle of approach, inter-trial interval, type of object, and hand size. When the experimenter's right arm was far (≧23 cm) from an instrumented object, proximity, appropriately, was not signaled. The movement sensor detected ≧98% of instrumented object movements when they were ≧6 cm long and ≧3 s apart, regardless of movement direction. No movement signals were recorded when instrumented objects were at rest. When the object to be manipulated and the arm to be used were randomly selected, the conjoint proximity and movement sensor signals detected handling of the object of interest with the right arm with 100% sensitivity and specificity even when the objects were just 5 cm apart.

The present disclosure allows a much richer objective picture of everyday arm activity after stroke than is possible using the devices and system of the art. Such an advance would permit more accurate measurement of real-world gains after upper-extremity rehabilitation. For this application, the patient's more-affected arm and a representative sample of household objects would be instrumented and the RF reader and processing device would be placed in the patient's home for several days before and after rehabilitation. Other rehabilitation applications are monitoring compliance with home exercise programs and therapeutic use of activity monitoring records. For example, the SERSMAA output could serve as input for software on the processing device controlling a virtual therapist who reinforces patients immediately after they use their more-affected arm to manipulate instrumented objects in their homes. Applications outside of medicine/rehabilitation include, but are not limited to, tracking how often consumers use a company's products (i.e., handle them) and monitoring who handles what on production lines, and also monitoring of control of the ball by a player or players of a sport. However, the system is not intended to be construed as limited to the aforementioned fields and usages.

### REFERENCES

[1] Lloyd-Jones, D., et al., Heart disease and stroke statistics—2010 update: a report from the American Heart Association. Circulation. 121(7): p. e46-e215.

[2] Lai, S. M., et al., Persisting consequences of stroke measured by the stroke impact scale. Stroke, 2002. 33: p. 1840-1844.

[3] Nichols-Larsen, D., et al., Factors influencing stroke survivors' quality of life during subacute recovery. Stroke, 2005.36: p. 1480-1484.

[4] Uswatte, G. and E. Taub, Implications of the learned nonuse formulation for measuring rehabilitation outcomes: lessons from Constraint-Induced Movement therapy. Rehabilitation Psychology, 2005. 50: p. 34-42.

[5] Gebruers, N., et al., Monitoring of physical activity after stroke: a systematic review of accelerometry-based measures. Archives of Physical Medicine and Rehabilitation. 2010. 91: p. 288-297.

[6] Uswatte, G., et al., Ambulatory monitoring of arm movement using accelerometry: an objective measure of upper-extremity rehabilitation in persons with chronic stroke. Archives of Physical Medicine and Rehabilitation, 2005. 86: p. 1498-1501.

[7] Ohashi, K., et al., Comparison of RFID Systems for Tracking Clinical Interventions at the Bedside. AMIA Annu Symp Proc, 2008: p. 525-9.

[8] ActiveWave, Inc. Products: conpactTag Datasheet. 2009 [cited 2011 Mar. 5]; Available from: http://www.activewaveinc.com/products_datasht_compacttag.php.

[9] Kim, D. S., et al., Design of RFID based the Patient Management and Tracking System in hospital. Conf Proc IEEE Eng Med Biol Soc, 2008. 2008: p. 1459-61.

[10] ActiGraph, LLC. 2010 [cited 2011 Mar. 5]; Available from: http://www.theactigraph.com/.

[11] Uswatte, G., et al., Objective measurement of functional upper extremity movement using accelerometer recordings transformed with a threshold filter. Stroke, 2000. 31: p. 662-667.

[12] Redmond, D. P. and F. W. Hegge, Observations on the design and specification of a wrist-worn human activity monitoring system. Behavior Research Methods, 1985. 17: p. 659-669.

What is claimed:

1. A system for the monitoring of the use and motion of a plurality of objects in a spatial environment, comprising:
a radio-frequency-identification-equipped tag attached to a first object in order to mark the object's location in the spatial environment, wherein the tag may be an active, passive or semi-passive transmitter of radio-frequency signals;
a transmitting component of a radio-frequency proximity sensor attached to the tag in order to track when a specifically-tagged second object is at a proximate distance to the object;
a receiving component of the radio-frequency proximity sensor connected to an active radio-frequency-identification-equipped tag specifically attached to the second object, wherein the tag may be an active, passive or semi-passive transmitter of radio-frequency signals;
a movement sensor attached to the specifically-tagged second object to monitor the speed of movement of the second object;
a stationary powered radio-frequency reader within the environment which reads radio-frequency signals synchronously emitted by the proximity sensor components and the active radio-frequency-identification-equipped tag attached to each object, as well as by the movement sensor, in order to track and measure the extents of movements of both objects in relation to each other and to the stationary point of the radio-frequency reader, in such a way as to detect their synchronous movement, wherein the proximity sensor components get activated at an adjustable mutual distance of between 1 inch and 16 inches;
a central processing unit, coupled to a memory and a writable media, connected to the reader by means of a data communication network so as to process and store readings from the reader in order to save data regarding movement of the first and second objects.

2. The system of claim 1, wherein the second object is a human functional body part and the first object is a tool moved by that body part.

3. The system of claim 1, further comprising a plurality of other objects, each object with an attached receiving component of the radio-frequency proximity sensor connected to an active, passive or semi-passive radio-frequency-identification-equipped tag, as well as an attached movement sensor to monitor the speed of movement of each object.

4. The system of claim 1, wherein the movement sensor may be a biaxial or triaxial accelerometer, a tilt sensor or a gyroscopic sensor.

5. The system of claim 3, wherein the movement sensor attached to each object may be a biaxial or triaxial accelerometer, a tilt sensor or a gyroscopic sensor.

6. The system of claim 1, wherein the radio-frequency-identification-equipped tag attached to the first object is an active transmitter of radio-frequency signals and the radio-frequency-identification-equipped tag attached to the second object is a passive or semi-passive transmitter of radio-frequency signals.

7. The method of claim 3, wherein each radio-frequency-identification-equipped tag attached to the first object as well as each of the plurality of other objects is an active transmitter of radio-frequency signals and the radio-frequency-identification-equipped tag attached to the second object is a passive or semi-passive transmitter of radio-frequency signals.

8. system of claim 2, wherein the human functional body part is a limb.

9. The system of claim 8, used in a therapeutic, a product manufacturing or a product use setting, wherein the limb is an arm and the tool is a suitable product whose handling is being monitored under the specific setting.

10. The system of claim 8, used in a sports setting, wherein the tool is a ball whose control by one or more players is being monitored.

11. A method for the monitoring of the use and motion of a plurality of objects in a spatial environment, comprising:
attaching a radio-frequency-identification-equipped tag to a first object in order to mark the object's location in the spatial environment, wherein the tag may be an active, passive or semi-passive transmitter of radio-frequency signals;
attaching a transmitting component of a radio-frequency proximity sensor to the tag in order to track when a specifically-tagged second object is at a proximate distance to the object;
attaching a receiving component of the radio-frequency proximity sensor and a connected radio-frequency-identification-equipped tag to the specific second object, wherein the tag may be an active, passive or semi-passive transmitter of radio-frequency signals;
attaching a movement sensor to the specifically-tagged second object to monitor the speed of movement of the second object;
reading by means of a stationary powered radio-frequency reader within the environment the radio-frequency signals synchronously emitted by the proximity sensor components and the active radio-frequency-identification-equipped tag attached to each object, as well as by the movement sensor;
tracking and measuring the extents of movements of both objects in relation to each other and to the stationary point of the radio-frequency reader, in such a way as to detect their synchronous movement, wherein the proximity sensor components get activated at an adjustable mutual distance of between 1 inch and 16 inches;
processing the readings from the reader via a central processing unit, coupled to a memory, and connected to the reader by means of a data communication network;
storing data regarding the movement of the first and second objects obtained from the processed readings to a writable media coupled to the central processing unit.

12. The method of claim 11, wherein the second object is a human functional body part and the first object is a tool moved by that body part.

13. The method of claim 11, further comprising the steps of:
attaching an active, passive or semi-passive radio-frequency-identification-equipped tag to each of a plurality of other objects, in order to mark each object's location in the spatial environment object, wherein the tag may be an active, passive or semi-passive transmitter of radio-frequency signals;
attaching a receiving component of a radio-frequency proximity sensor to each of the tags in order to track when the second object is at a proximate distance to each object; and
attaching a movement sensor to each object monitor its speed of movement;
reading by means of a stationary powered radio-frequency reader within the spatial environment the radio-frequency signals synchronously emitted by each of the proximity sensor components and the active radio-frequency-identification-equipped tag attached to each object, as well as by the movement sensor attached to each object;
tracking and measuring the extents of movements of each of the objects in relation to the first object and to the stationary point of the radio-frequency reader, in such a way as to detect their synchronous movement with the first object, wherein the proximity sensor components of each object get activated when at an adjustable distance of between 1 inch and 16 inches from the first object;
processing the readings from the reader via a central processing unit, coupled to a memory, and connected to the reader by means of a data communication network;
storing data retarding the movement of each of the objects in relation to the first object obtained from the processed readings to a writable media coupled to the central processing unit.

14. The method of claim 11, wherein the movement sensor may be a biaxial or triaxial accelerometer, a tilt sensor or a gyroscopic sensor.

15. The method of claim 13, wherein the movement sensor attached to each object may be a biaxial or triaxial accelerometer, a tilt sensor or a gyroscopic sensor.

16. The method of claim 11, wherein the radio-frequency-identification-equipped tag being attached to the first object is an active transmitter of radio-frequency signals and the radio-frequency-identification-equipped tag being attached to the second object is a passive or semi-passive transmitter of radio-frequency signals.

17. The method of claim 13, wherein each radio-frequency-identification-equipped tag being attached to the first object as well as each of the plurality of other objects is an active transmitter of radio-frequency signals and the radio-frequency-identification-equipped tag being attached to the second object is a passive or semi-passive transmitter of radio-frequency signals.

18. The method of claim 12, wherein the human functional body part is a limb.

19. The method of claim 18, used in a therapeutic, a product manufacturing or a product use setting, wherein the limb is an arm and the tool is a suitable product whose handling is being monitored under the specific setting.

20. The method of claim 18, used in a sports setting, wherein the tool is a ball whose control by one or more players is being monitored.
